(19) United States
(12) Patent Application Publication
(10) Pub. No.: US 2011/0099325 A1
(43) Pub. Date: Apr. 28, 2011

(54) USER DEVICE AND MAPPING DATA MANAGEMENT METHOD THEREOF

(75) Inventors: Kangho Roh, Seoul (KR); Chanik Park, Hwaseong-si (KR)

(73) Assignee: SAMSUNG ELECTRONICS CO., LTD., Suwon-si (KR)

(21) Appl. No.: 12/912,847

(22) Filed: Oct. 27, 2010

Related U.S. Application Data
(60) Provisional application No. 61/255,119, filed on Oct. 27, 2009.

(30) Foreign Application Priority Data
Jul. 14, 2010 (KR) 10-2010-0068117

(51) Int. Cl. G06F 12/02

(52) U.S. Cl. 711/103; 711/E12.008

(57) ABSTRACT

In the mapping data management method, data that is being used by a host is stored in response to a power-off command from a user. The host generates a power-off notification signal to a storage device. The storage device stores mapping data of a volatile memory in a nonvolatile memory in response to the power-off notification signal.

### CROSS-REFERENCE TO RELATED APPLICATIONS

A claim of priority under 35 U.S.C. §119 is made to U.S. Provisional Patent Application No. 61/255,119, filed on Oct. 27, 2009, and to Korean Patent Application No. 10-2010-0068117, filed on Jul. 14, 2010, the entire contents of which are hereby incorporated by reference.

### BACKGROUND

The present disclosure herein relates to a user device, and more particularly, to a user device including a storage device based on a nonvolatile memory and a mapping data management method thereof.

Semiconductor memory is generally classified as either volatile semiconductor memory or nonvolatile semiconductor memory. A volatile semiconductor memory device exhibits a relatively high read and write speed, but the data stored therein is lost when power is shut off or interrupted. In contrast, a nonvolatile semiconductor memory device retains stored data in the absence of supplied power.

Examples of nonvolatile semiconductor memory devices include Mask Read-Only Memory (MROM), Programmable Read-Only Memory (PROM), Erasable Programmable Read-Only Memory (EPROM) and Electrically Erasable Programmable Read-Only Memory (EEPROM).

Among nonvolatile memories, a flash memory is widely used as the audio and video data storage medium of information devices such as computers, portable phones, Personal Digital Assistants (PDAs), digital cameras, voice recorders, MP3 players, personal portable terminals, handheld personal computers, game machines, fax machines, scanners and printers (which are referred to as a host).

Moreover, a flash memory, for example, may be configured in an attachable card type like Multimedia Cards (MMCs), Secure Digital (SD) cards, smartmedia cards or compact flash cards, and it may be included as a main storage device in mess storage devices such as Universal Serial Bus (USB) memories and Solid State Drives (SSDs). A storage device including the flash memory may be inserted into a user device and be used, or may be disconnected from the user device, according to the desires of a user.

As the functions of user devices are diversified, the kinds of data, programs and operation modes that are stored in flash memories are diversified. Accordingly, a data management method is desired which can effectively support the diversified data, programs and operation modes of the flash memories.

### SUMMARY

Embodiments of the inventive concepts provide a mapping data management method including storing data that is being used by a host in response to a power-off command from a user, generating, by the host, a power-off notification signal to a storage device, and storing, by the storage device, mapping data of a volatile memory in a nonvolatile memory in response to the power-off notification signal.

In other embodiments of the inventive concepts, a mapping data management method includes receiving, by an operating system, a power-off command inputted from a user, storing, by the operating system, data that is being used by a host in response to the power-off command, generating, by the operating system, a power-off notification signal to a storage device, and storing, by the storage device, mapping data of a volatile memory in a nonvolatile memory in response to the power-off notification signal.

In still other embodiments of the inventive concept, a user device includes a host storing data that is being used in response to a power-off command inputted from a user and generating a power-off notification signal, and a storage device mapping data of a volatile memory in a nonvolatile memory in response to the power-off notification signal.

### BRIEF DESCRIPTION OF THE DRAWINGS

The accompanying drawings are included to provide a further understanding of the inventive concepts, and are incorporated in and constitute a part of this specification. The drawings illustrate exemplary embodiments of the inventive concepts and, together with the description, serve to explain principles of the inventive concepts. In the drawings:

FIG. 1 is a block diagram exemplarily illustrating a storage device and a user device including the same, according to an embodiment of the inventive concepts;

FIG. 2 is a block diagram exemplarily illustrating the configuration of a storage controller of FIG. 1, according to an embodiment of the inventive concepts;

FIG. 3 is a block diagram exemplarily illustrating the configuration of a storage controller of FIG. 1, according to another embodiment of the inventive concepts;

FIG. 4 is a block diagram exemplarily illustrating the detailed configuration of the user device of FIG. 1;

FIG. 5 is a block diagram exemplarily illustrating the configuration of a user device according to another embodiment of the inventive concepts;

FIG. 6 is a diagram illustrating the structure of a mapping table according to an exemplary embodiment of the inventive concepts;

FIGS. 7 to 10 are diagrams illustrating a mapping data management method according to an exemplary embodiment of the inventive concepts;

FIG. 11 is a flow chart illustrating an operation of the host for performing a mapping data management method according to an exemplary embodiment of the inventive concepts;

FIG. 12 is a flow chart illustrating an operation of the host for performing a mapping data management method according to an exemplary embodiment of the inventive concepts;

FIG. 13 is a flowchart illustrating a method for managing mapping data in storage devices 1200 and 2200 according to an embodiment of the inventive concepts;

FIGS. 14 and 15 are diagrams illustrating configurations of user devices 3000 and 4000 having an auxiliary power source in the storage devices 1200 and 2200;

FIG. 16 is a diagram illustrating an address mapping data restoring method that can be performed when an auxiliary power source is absent in the storage devices 1200 and 2200 and a sudden power-off condition occurs;

FIG. 17 is a diagram illustrating a configuration of a user device 5000 according to still another embodiment of the inventive concept. The user device 5000 may include a storage device 1200 according to an embodiment of the inventive concepts; and

FIG. 18 is a diagram illustrating a configuration of a storage device 6000 according to another embodiment of the inventive concepts.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

A storage device according to embodiments of the inventive concepts will be described below as an example, and the storage device may be amended or modified according to viewpoints and applications without departing from the scope, technical idea and other objects of the present inventive concepts. For example, in embodiments of the inventive concept, an SSD that uses a flash memory among a semiconductor memory as a main storage device will be described below as a storage device. However, a storage device and a data storage method thereof according to embodiments of the inventive concepts may be applied to an SSD and various types of storage devices, for example, memory cards.

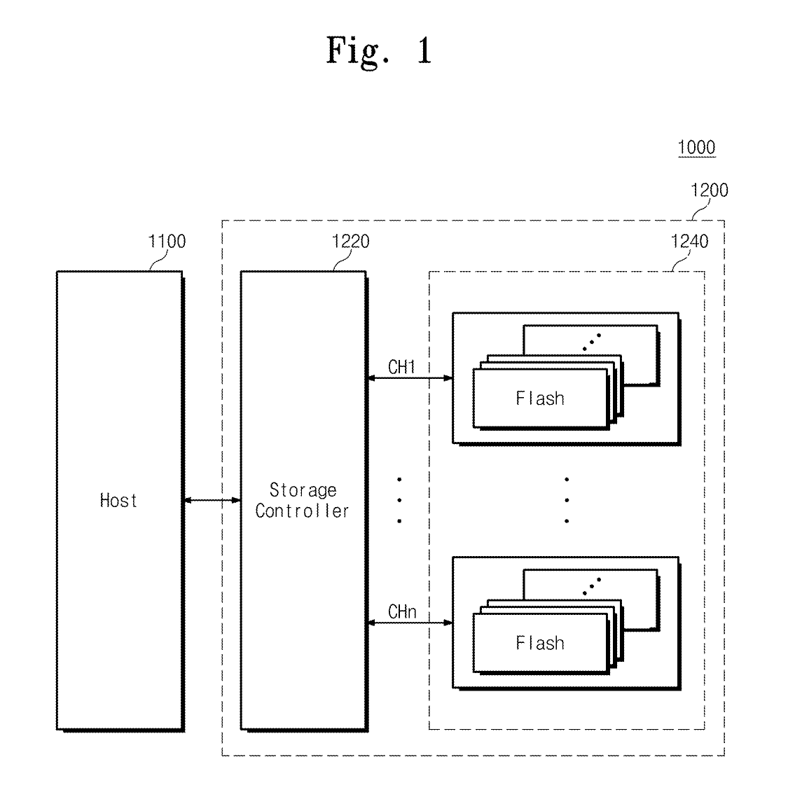

FIG. 1 is a block diagram exemplarily illustrating a storage device 1200 and a user device 1000 including the same, according to an embodiment of the inventive concepts.

Referring to FIG. 1, a user device 1000 according to an embodiment of the inventive concepts may include a host 1100 and a storage device 1200. The host 1100 may control the storage device 1200. The host 1100, for example, may include a portable electronic device such as a personal/portable computer, a PDA, a Portable Media Player (PMP) and an MP3 player. The host 1100 and the storage device 1200 may be connected through a standardized interface such as a USB interface, Small Component Small Interface (SCSI), Enhanced Small Disk Interface (ESDI), Serial-Advanced Technology Attachment (SATA), Serial Attached SCSI (SAS), Peripheral Component Interconnection (PCI)-express or Integrated Drive Electronics (IDE). An interface scheme for connecting the host 1100 and the storage device 1200 is not limited to a specific scheme, and it may be variously implemented.

The storage device 1200 may be configured as a semiconductor disk (for example, a Solid State Disk or a Solid State Drive, which is referred to as an SSD below). In an embodiment of the inventive concept, a case where the storage device 1200 is configured with an SSD will be exemplarily described below. However, this is merely an applied example of an embodiment of the inventive concepts, and the storage device 1200 is not limited to an SSD and may be configured in various types. For example, the storage device 1200 may be integrated in one semiconductor device and configured as a PC card (Personal Computer Memory Card International Association (PCMCIA)), a Compact Flash (CF) card, a Smart Media (SM) Card (SMC), a memory stick, a multimedia card (MMC, RS-MMC, MMC-micro), an SD card (SD, miniSD, microSD, SDHC) and a Universal Flash Storage (UFS).

The storage device 1200 may include a storage controller 1220 and a main storage unit 1240. The storage controller 1220 may control the read/writing/erase operation of the main storage unit 1240 in response to a request from the host 1100.

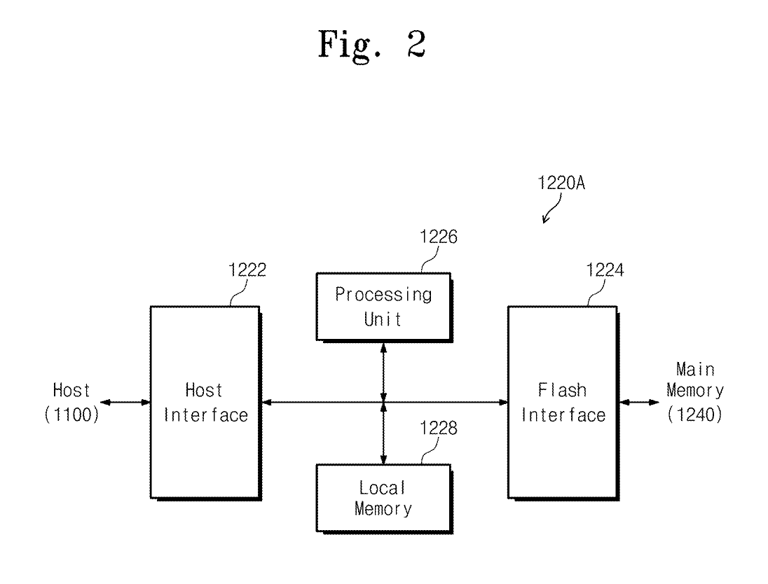

FIG. 2 is a block diagram exemplarily illustrating the configuration of the storage controller 1220 of FIG. 1, according to an embodiment of the inventive concepts.

Referring to FIG. 2, a storage controller 1220A may be configured as an SSD controller in a case where the storage device 1200 is configured as an SSD. The storage controller 1220A may include a host interface 1222, a flash interface 1224, a processing unit 1226, and a local memory 1228. The configuration of the storage controller 1220A of FIG. 2 relates to an applied example of an embodiment of the inventive concepts, and may be modified and changed into various forms. For example, although not shown in FIG. 2, the storage controller 1220A may further include an Error Correction Code (ECC) circuit for detecting and correcting the error of data that is stored in the main storage unit 1240.

The host interface 1222 may provide an interface with the host 1100, and the flash interface 1224 may provide an interface with the main storage unit 1240. The processing unit 1226 may control the overall operation of the storage controller 1220A. In an exemplary embodiment of the inventive concepts, the processing unit 1226 may be a commercially available or custom microprocessor.

The local memory 1228 may be one or more memory devices that include software and data for operating the storage device 1220. The local memory 1228 may include a cache, a Read Only Memory (ROM), a Programmable Read Only Memory (PROM), an Erasable Programmable Read Only Memory (EPROM), an Electrical Erasable Programmable Read Only Memory (EEPROM), a flash memory, a Phase-change Random Access Memory (PRAM), a Static Random Access Memory (SRAM) and a Dynamic Random Access Memory (DRAM). Moreover, the local memory 1228 may be used to temporarily store data that is to be stored in the main storage unit 1240 or is read from the main storage unit 1240.

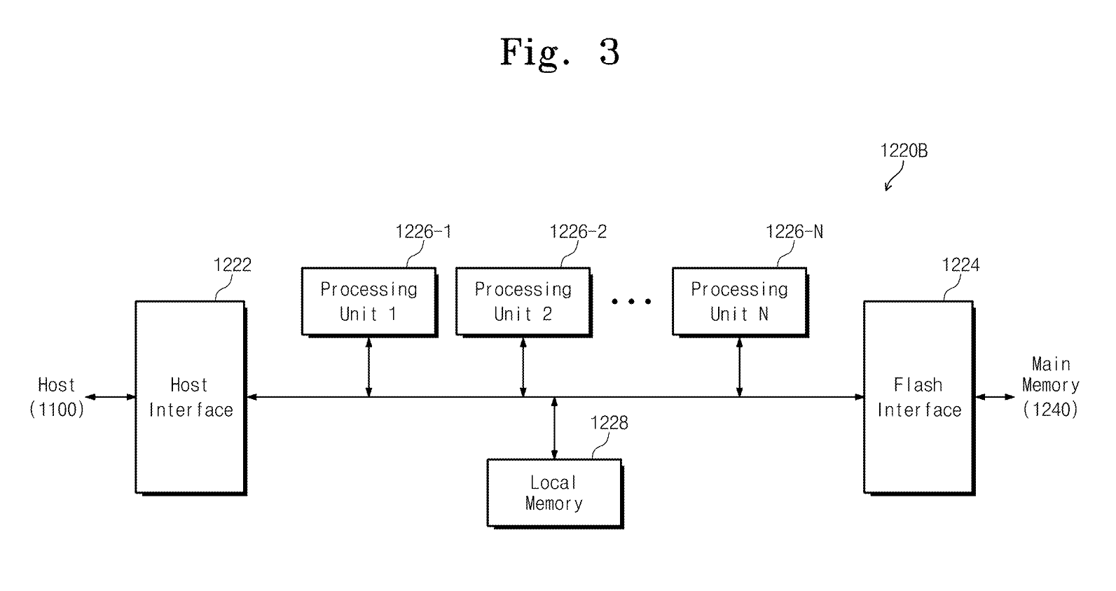

FIG. 3 is a block diagram exemplarily illustrating the configuration of the storage controller 1220 of FIG. 1, according to another embodiment of the inventive concepts. In FIG. 3, a case where a plurality of processing units 1226 to 1226_N is included in a storage controller 1220B is exemplarily illustrated. As illustrated in FIG. 3, a case where the processing units 1226 to 1226_N are included in a storage controller 1220B is called a multi core processor. As illustrated in FIG. 2, a case where one processing unit 1226 is included in the storage controller 1220A is called a single core processor.

The storage controller 1220B may perform an overall operation through the processing units 1226 to 1226_N. The storage controller 1220B may divide a plurality of control operations by a certain number and allocate the divided control operations to the processing units 1226 to 1226_N. According to this configuration, a plurality of control operations may be performed in parallel. In another exemplary embodiment of the inventive concepts, the processing units 1226 to 1226_N may respectively correspond to a plurality of channels CH1 to CHn and perform independent control for the respective channels CH1 to CHn. According to this configuration, although the storage controller 1220B is driven by a low frequency clock, the performance of the storage controller 1220B including the processing units 1226 to 1226_N may be improved.

Referring again to FIG. 1, the storage controller 1220 may be connected to the main storage unit 1240 through the channels CH1 to CHn.

The main storage unit 1240 may be configured with a plurality of nonvolatile memory chips, for example, a plurality of flash memories. A plurality of flash memory chips may be connected to the respective channels CH1 to CHn in common. In another embodiment of the inventive concepts, the main storage unit 1240 may be configured with nonvolatile memory chips (for example, PRAM, FRAM and MRAM) which are different from the flash memory chips. Alternatively, the main storage unit 1240 may be configured with a nonvolatile memory such as a DRAM or an SRAM, or it may be configured in a hybrid type where at least two different memories are mixed.

When the main storage unit 1240 is configured with a plurality of nonvolatile memory chips (for example, a plurality of flash memory chips), the storage device 1200 can retain stored data even when a power is shut off. Each of the flash memory chips configuring the main storage unit 1240 may be configured with a plurality of memory cells having a string structure. A set of such memory cells is called a cell array. A memory cell array of the main storage unit 1240 may be configured with a plurality of blocks. Each of the blocks may be configured with a plurality of pages. Each of the pages may be configured with a plurality of memory cells sharing one word line. Memory cells pertaining to one or more pages may correspond to one word line. 1-bit data or k-bit data (where k is an integer equal to or more than 2) may be stored in each of the memory cells.

In the main storage unit 1240, an erase operation is performed in block units, and a read and writing operation is performed in page units. In another embodiment of the inventive concepts, the unit of the read and writing operation may be performed in page units, and may be performed in sub-page units less than one page. As described above, in the main storage unit 1240 configured with a flash memory, the unit of the read/writing operation differs from the unit of the erase operation. Moreover, unlike other semiconductor memory devices, overwriting is not performed in the main storage unit 1240. That is, in the main storage unit 1240, the erase operation should be necessarily performed before the writing operation is performed.

However, the existing file system (generally, a file system is stored in a host side in software) is designed in consideration of an overwriting-enabled storage device like a Hard Disk Drive (HDD). Accordingly, the operational characteristic of a flash memory where an erase operation should be first performed before a writing operation is not reflected in the existing file system. Furthermore, since the unit of data written differs from the unit of data erased in a flash memory, an address provided from the file system may be mismatched with an address of the flash memory in which data has been written.

This feature makes it difficult to use a flash memory as a main memory, and moreover, it prevents a file system for an HDD from being used as-is when the flash memory is used as a sub-storage device. Accordingly, in order for the erase operation of a flash memory to be hidden in a file system side, a Flash Translation Layer (FTL) may be used between the file system and the flash memory. The FTL is stored in the one area of the main storage unit 1240 and then may be loaded to the storage controller 1220 in a power-on operation. The FTL loaded to the storage device 1220 may be stored in the local memory 1228 and driven.

The FTL may perform address-physical address mapping information management, bad block management, data retainment management due to the unpredicted shutoff of a power and wear management. For example, the FTL may map a logical address, which is generated by a file system in the writing operation of a flash memory, to the physical address of the flash memory where an erase operation has been performed. The FTL may use an address mapping table in order for fast address mapping to be performed. Due to the address mapping function of the FTL, the host 1100 may recognize a flash memory device as an HDD (or SRAM), and it may access the flash memory device in the same scheme as that of the HDD.

Moreover, even when a power is shut off, the FTL should retain the data of a user. For this, in a power-on operation, an address mapping table should be recovered to the same state as a state before the power is shut off. However, as the capacity of the storage device 1200 and the capacity of the main storage unit 1240 increase and a degree of integration of a flash memory becomes higher, the desired capacity of an address mapping table increases also. The increase of capacity of the address mapping table may cause an increase in the managing cost of the address mapping table, and may extend the time expended until the address mapping table is recovered.

For solving these limitations, in an embodiment of the inventive concepts, the address mapping table may be distributed to the local memory 1228 and the main storage unit 1240 configured with a flash memory and be configured. When a power-off operation is performed (i.e., before the power is shut off), address mapping information stored in the local memory 1228 may be stored in the main storage unit 1240. For example, when a power-off command is inputted from a user, the storage controller 1220 may store address mapping information, which is stored in the local memory 1228, in the main storage unit 1240 in response to power-off notification that is generated from the host 1100.

When address mapping information, which was stored in the local memory 1228 before a power is turned off, is not stored in the main storage unit 1240, address mapping information stored in the local memory 1228 should be recovered through a separate recovery operation.

The power-off operation may be classified as either a normal power off where a user normally shuts off a power or a sudden power off that is abnormally performed due to the disconnection of a battery or the depletion of a battery. Whether the power-off operation that is performed at a current time is the normal power off or the sudden power off may be determined only by an Operating System (OS) of the host 1100 that directly receives a power-off command from the user. That is, the FTL of the storage device 1200 may determine whether a power-off operation that is performed at a current time is the normal power off or the sudden power off. Accordingly, for guaranteeing the stability of a system, an address mapping table may be recovered each time a rebooting operation is performed, in consideration of the sudden power off corresponding to the worst case. In this case, for recovering the address mapping table, an operation may be required in which the FTL scans additional information that is stored in a memory block of the main storage unit 1240. Time taken in a scan operation is extended as the data storage capacity of the main storage unit 1240 increases, and an initial recognition time for a flash memory may increase in a rebooting operation.

In the storage device 1200, however, since all address mapping information that was stored in the local memory 1228 before power off may be stored in the main storage unit 1240, the address mapping information need not be recovered in a rebooting operation, and the initial recognition time of a flash memory is shortened. As the capacity of the storage device 1200 and the capacity of the main storage unit 1240 increase and a degree of integration of the flash memory becomes higher, the initial recognition characteristic of the inventive concepts improves.

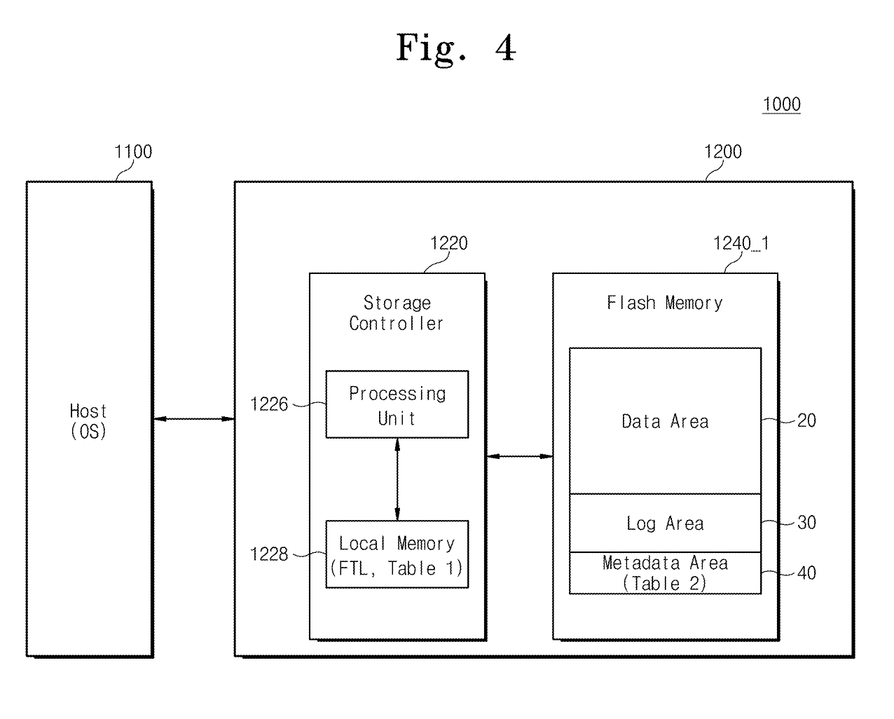

FIG. 4 is a block diagram exemplarily illustrating a detailed configuration of the user device 1000 of FIG. 1.

Referring to FIG. 4, a user device 1000 may include a host 1100 and a storage device 1200. The host 1100 may control the storage device 1200. The host 1100 and the storage device 1200 may be connected through a standardized interface such as ATA, SATA, SAS, PATA, USB, SCSI, ESDI, IEEE 1394, IDE, PCI-express and/or card interface.

A processor (not shown) for controlling the operation of the user device 1000 may be included in the host 1100. The processor may be a commercially available or custom processor. The processor included in the host 1100 may include electronic elements such as a Central Processing Unit (CPU) and a microprocessor. In an exemplary embodiment of the inventive concepts, the processor may be configured as a CPU. One or more memory devices, which store data and software for operating the user device 1000, may be connected to the processor. The memory device may include a memory device such as a cache, a ROM, a PROM, an EPROM, an EEPROM, an SRAM and a DRAM.

An OS may be included in a memory device of the host 1100. The OS may control the overall operation of the host 1100. For example, the OS may control the software and/or hardware resource of the host 1100, and it may control program execution by the processor. Moreover, when power off is requested from a user, the OS may perform control so that information which is being operated in the host 1100 may be stored in a safety location. When the information which is being operated in the host 1100 may be stored in the safety location, the OS may generate a power-off notification signal to the storage device 1200. The storage device 1200 may store address mapping data, which is stored in a volatile memory area, in a nonvolatile memory area in response to the power-off notification signal that is provided from the host 1100. An operation for storing address mapping data according to an embodiment of the inventive concepts that is performed upon power off will be described below in detail.

The storage device 1200 may include a main storage unit 1240_1 and a storage controller 1220. The main storage unit 1240_1 is for storing data (which includes all storage-enabled data such as document data, video data, music data and program data), and it may be configured with a nonvolatile memory such as a flash memory. In FIG. 4, one element among a plurality of flash memories configuring the main storage unit 1240_1 is exemplarily illustrated, but the main storage unit 1240_1 is not limited thereto. The main storage unit 1240_1 may be configured in various types.

The storage controller 1220 may control the main storage unit 1240_1 in response to an access request from the host 1100. The storage controller 1220 may include a processing unit 1226 and a local memory 1228. The local memory 1228 may be called an internal memory, a working memory, or a buffer memory.

The local memory 1228 is used for sending data between the host 1100 and the main storage unit 1240_1, and it may be configured as a high-speed volatile memory such as a DRAM or an SRAM, or a nonvolatile memory such as an MRAM, a PRAM, a FRAM, a NAND flash memory or a NOR flash memory.

The local memory 1228 may operate as a writing buffer. For example, the local memory 1228 may operate as a writing buffer for temporarily storing data to be written in the main storage unit 1240_1 according to the request of the host 1100. Moreover, the function of the writing buffer may be optionally used. For example, depending on the case, data transferred from the host 1100 may be directly sent to the main storage unit 1240_1 without passing through the writing buffer, i.e., the local memory 1228. The function of the storage device 1200 is called a writing bypass function.

Alternatively, the local memory 1228 may operate as a read buffer. For example, the local memory 1228 may operate as a read buffer for temporarily storing data that is read from the main storage unit 1240_1, according to the request of the host 1100. The local memory 1228 may include one or more memories. In this case, each of the memories may be used as a writing buffer, a read buffer or a buffer having all two functions (i.e., writing and read functions). The local memory 1228 is not limited to a specific type, and it may be configured in various types.

The processing unit 1226 may control the local memory 1228 and the main storage unit 1240_1. When a read command is inputted from the host 1100, the processing unit 1226 may control the main storage unit 1240_1 in order for data stored in the main storage unit 1240_1 to be moved to the host 1100. Alternatively, when a read command is inputted from the host 1100, the processing unit 1226 may control the main storage unit 1240_1 and the local memory 1228 in order for data, provided from the main storage unit 1240_1 to the local memory 1228, to be moved to the host 1100.

When a writing command is inputted from the host 1100, the processing unit 1226 may temporarily store data associated with the writing command in the local memory 1228. All or a portion of data that is temporarily stored in the local memory 1228 may be moved to the main storage unit 1240_1 according to the control of the processing unit 1226 when the free space of the local memory 1228 is insufficient in a normal operation or an idle time occurs (which is the idle time of the storage controller 1220 that occurs when there is no request from the host 1100). In this way, an operation for compulsorily storing data, stored in the processing unit 1226, in the main storage unit 1240_1 is called a flush. A flush operation may be performed even while a normal operation and/or a power-off operation are being performed.

In addition, an FTL may be stored in the local memory 1228. Moreover, a mapping table Table1 may be configured in the local memory 1228 and be stored an address mapping result that is performed by the FTL. In an embodiment of the inventive concepts, the mapping table Table1 stored in the local memory 1228 is referred to as a first mapping table. The data of the first mapping table Table1 stored in the local memory 1228 may be stored in the main storage unit 1240_1 through a flush operation that is performed according to the control of the processing unit 1226.

For example, when a power-off command is inputted from a user to the host 1100, the host 1100 may generate a power-off notification signal to the storage controller 1220 through an OS. In an exemplary embodiment of the inventive concepts, the power-off notification signal may be generated after data that is being operated in the host 1100 is stored in a safety location. The processing unit 1226 may perform control for a flush operation to be performed in the local memory 1228, in response to the power-off notification signal that is generated from the host 1100. As a result, all address mapping data may be stored in the main storage unit 1240_1 being a nonvolatile memory before power off, and the consistency of data can be guaranteed even without recovering the address mapping data when rebooting.

In another embodiment of the inventive concepts, a flush operation for storing the data of the first mapping table Table1 in the main storage unit 1240_1 may be performed at certain intervals according to the control of the processing unit 1226. The flush operation for the data of the first mapping table Table1 may be implemented in various forms.

The main storage unit 1240_1 configured with a flash memory may include a data area 20, a log area 30 and a metadata area 40.

The log blocks of the log area 30 may respectively correspond to the data blocks of the data area 20. When intending to write data in the data block of the data area 20, the data may be stored in a log block corresponding to the data block without being directly written in the data block. However, when a log block corresponding to the data block of the data area 20 is not designated or an empty page does not exist in the log block of the log area 30 or there is a request from the host 1100, a merge operation may be performed. Through the merge operation, the valid page of the log block and the valid page of the data block may be stored in a new data block or log block. When the merge operation is performed or a writing or erase operation is performed according to a user's request, mapping information may be changed.

The changed mapping information may be stored in a table type Table2 in the metadata area. In an embodiment of the inventive concepts, a mapping table Table2 stored in the metadata area 40 of the main storage unit 1240_1 is called a second mapping table. When a power-off command is inputted from a user, the data of the first mapping table Table1 may be stored in the second mapping table Table2 of the metadata area 40.

Moreover, although not shown in FIG. 4, the main storage unit 1240_1 may further include a free area. The free area may be a plurality of free blocks. When a log block is insufficient during an address mapping operation, a free block may be allocated as a log block and used.

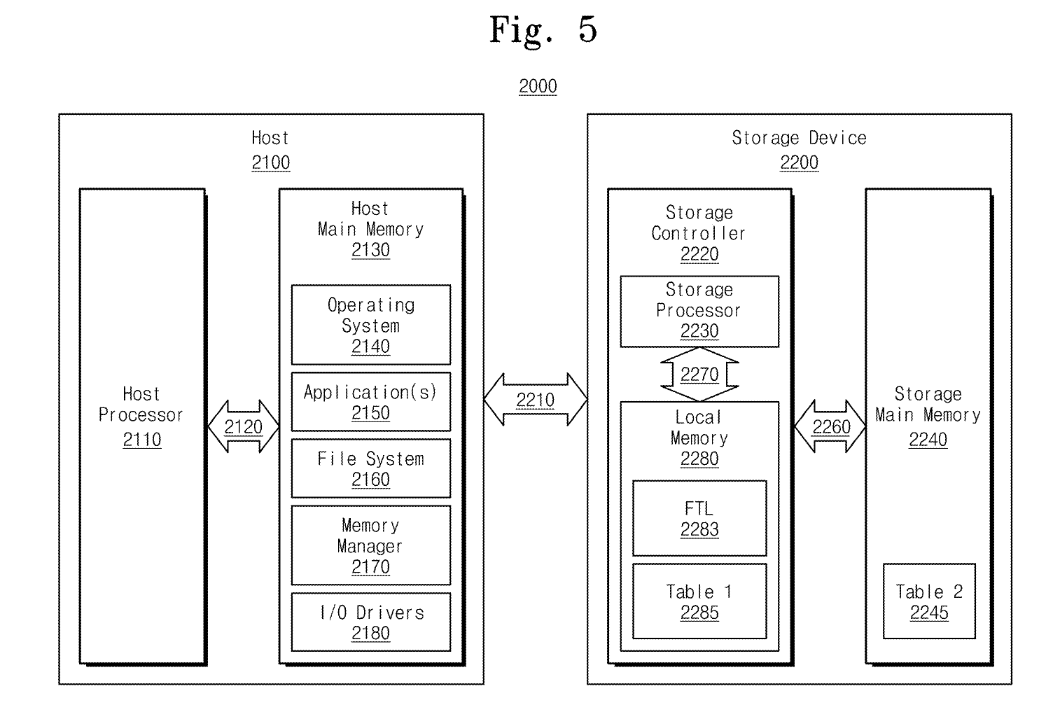

FIG. 5 is a block diagram exemplarily illustrating the configuration of a user device 2000 according to another embodiment of the inventive concepts.

Referring to FIG. 5, a user device 2000 according to another embodiment of the inventive concepts may include a host 2100 and a storage device 2200. According to another embodiment of the inventive concepts, the host 2100 may be a PDA, a computer, a digital audio player, a digital camera, and a mobile terminal.

The host 2100 and the storage device 2200 may be connected through an interface 2210. The interface 2210 may be a standardized interface such as ATA, SATA, SAS, PATA, USB, SCSI, ESDI, IEEE 1394, IDE, PCI-express and/or card interface.

The host 2100 may include a host processor 2110 that communicates with a host main memory 2130 through an address/data bus 2120. In another exemplary embodiment of the inventive concepts, the host processor 2110 may be a commercially available or custom processor. The host main memory 2130 may be configured with one or more memory devices that include data and software for operating the user device 2000. The host main memory 2130 may include a memory device such as a ROM, a PROM, an EPROM, an EEPROM, a flash memory, an SRAM and a DRAM.

As illustrated in FIG. 5, the host main memory 2130 may include a plurality of software and/or data categories. The software and/or data categories may include an OS 2140, an application 2150, a file system 2160, a memory manager 2170, and an input/output (I/O) driver(s) 2180.

The OS 2140 may control the operation of the host 2100. In more detail, the OS 2140 may control the software and/or hardware resource of the host 2100, and it may control program execution that is performed in the host processor 2110. The application 2150 may include various application programs that are executed in the host 2100.

Moreover, when power off is requested from a user, the OS 2140 may perform control so that information which is being operated in the host 2100 may be stored in a safety location. When the information which is being operated in the host 2100 may be stored in the safety location, the OS 2140 may generate a power-off notification signal to the storage device 2200. The storage device 2200 may store address mapping data, which is stored in a volatile memory area, in a nonvolatile memory area in response to the power-off notification signal that is provided from the host 2100.

The file system 2160 may store computer files and/or data in a storage area such as the host main memory 2130 and/or the storage device 2200 or systematize them. The file system 2160 may be used according to the OS 2140 that is executed in the host 2100. The memory manager 2170 may perform a memory access operation that is performed in the host main memory 2130 internal to the host 2100, and it may control a memory access operation that is performed in the storage device 2200 external to the host 2100. The input/output driver 2180 may transfer information between another device such as the storage device 2200, a computer system, or a network (for example, Internet) and the host 2100.

The storage device 2200 may include a storage controller 2220 that communicates with a main storage unit 2240 through an address/data bus 2260. The main storage unit 2240 may be a memory of various types where an erase operation is performed before a writing operation. Moreover, the main storage unit 2240 may be a memory having nonvolatile characteristics where data is retained even after a power is turned off. A second mapping table 2245 may be stored in the main storage unit 2240. Exemplarily, the storage device 2200 may be a memory card device, an SSD device, a multimedia card device, an SD device, a memory stick device, an HDD device, a hybrid drive device, or a serial bus flash device.

The storage controller 2210 may include a storage processor 2230 that communicates with a local memory 2280 through an address/data bus 2270. In another exemplary embodiment of the inventive concepts, the storage processor 2230 may be a commercially available or custom processor.

The local memory 2280 may be one or more memory devices that include data and software for operating the storage device 2200. The local memory 2280 may include a ROM, a PROM, an EPROM, an EEPROM, a flash memory, an SRAM and a DRAM. The local memory 2280 may include a plurality of software and/or data categories. As the software and/or data category, for example, an FTL module 2283 and a first mapping table 2285 may be stored in the local memory 2280.

The FTL module 2283 is stored in one area (for example, a metadata area) of the main storage unit 2240 and then may be loaded to the local memory 2280 in a power-on operation. The FTL module 2283 may perform address-physical address mapping information management, bad block management, data retainment management due to unanticipated shutoff of power and wear management. For example, the FTL module 2283 may map a logical address, which is generated by a file system in the writing operation of a flash memory, to the physical address of a flash memory where an erase operation has been performed. The FTL module 2283 may use an address mapping table in order for fast address mapping to be performed. In another embodiment of the inventive concepts, the address mapping table may be configured to be distributed to the local memory 2280 and the main storage unit 2240.

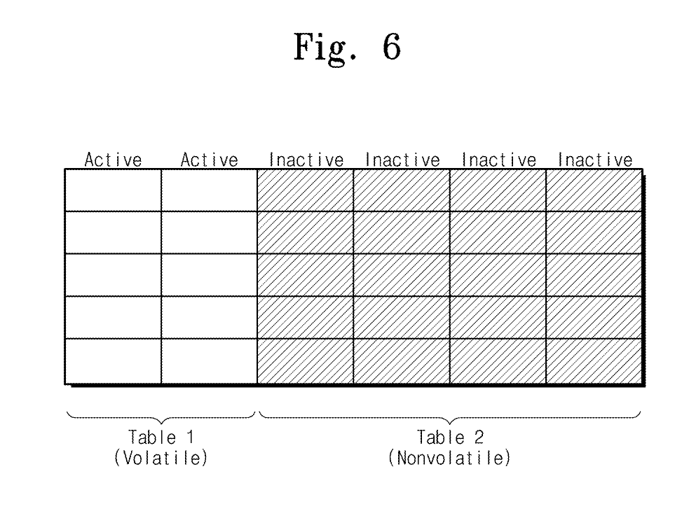

FIG. 6 is a diagram illustrating the structure of a mapping table according to an exemplary embodiment of the inventive concepts.

Referring to FIG. 6, a mapping table according to an exemplary embodiment of the inventive concepts may be divided into a first address mapping table Table1 and a second address mapping table Table2. For example, the first address mapping table Table1 may be stored in the first local memory 1228/2280 may store and the second address mapping table Table2 may be stored in the main storage unit 1240/2240. Both of the first and second address mapping table Table1 and Table2 may be configured and updated by the flash translation layer (FTL) module 2283.

The capacity of the address mapping tables also increases as the data storage capacity of the storage device 1220/2200 and the main storage unit 1240/2240 increases. The address mapping tables must be frequently updated whenever a data write/read operation is performed, and also when a merge operation is performed. Thus, if the address mapping table is provided only in the main storage unit 1240/2240, the performance of the storage device 1220/2200 may degrade due to the non-overwrite characteristic of a flash memory. Also, since the allowable erase count of the flash memory is fixed (for example, 100,000 times), the frequent erase operations for update of mapping data may reduce the lifetime of the flash memory. In order to prevent this limitation, the inventive concepts may store/manage the address mapping tables in a volatile memory and a nonvolatile memory in a distributed manner.

As illustrated in FIG. 6, a mapping table area stored in the local memory 1228/2280, i.e., a volatile memory may be defined as an active area and a mapping table area stored in the main storage unit 1240/2240, i.e., a nonvolatile memory may be defined as an inactive area. The active area may be set/changed variously by the designer.

The mapping data corresponding to the active area may be stored in the first address mapping table Table1. The mapping data corresponding to the inactive area may be stored in the second address mapping table Table2. The mapping data stored in the first address mapping table Table1 may be transferred from the first address mapping table Table1 to the second address mapping table Table2 in response to a power-off request of the host 1100/2100. Consequently, in a power-off mode, all of the mapping data may be stored in the main storage unit 1240/2240 that is a volatile memory.

According to the above configuration of the inventive concepts, the mapping data of the active area may be freely updated in a normal operation without limitation in the overwrite/erase count, and may be retained in the nonvolatile memory in a power-off mode. Thus, there is no need to recover the mapping data in a reboot operation. Consequently, the data retention cost of the address mapping table can be reduced and the initial recognition time for the flash memory in the reboot operation can be minimized. The data retention cost and performance of the address mapping table can improve as the size of the active area increases.

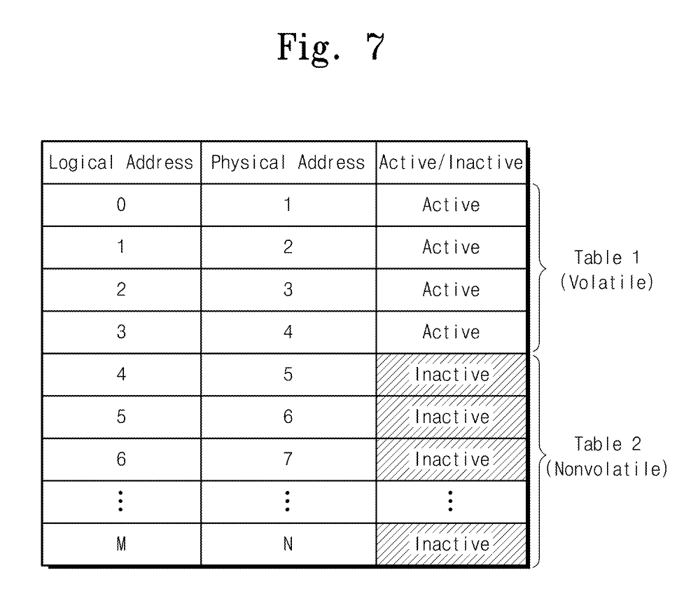

FIGS. 7 to 10 are diagrams illustrating a mapping data management method according to an exemplary embodiment of the inventive concepts. FIGS. 7 to 10 illustrate an exemplary structure of the address mapping table and a mapping data management method according to its active/inactive state.

FIG. 7 illustrates an example of the structure of mapping tables corresponding respectively to an active area and an inactive area in a normal operation.

Referring to FIG. 7, an address mapping table may include a plurality of mapping data. The mapping data illustrated in FIG. 7 may be page-based mapping data or block-based mapping data. The structure of the mapping data illustrated in FIG. 7 may vary according to an applied mapping scheme.

Each of the mapping data may define the corresponding relationship between a logical address and a physical address. FIG. 7 illustrates 0^{th} to M^{th} logical addresses and 1^{st} to N^{th} physical addresses. The corresponding relationship between the logical address and the physical address may be determined by an address mapping operation of the flash translation layer (FTL). The flash translation layer may perform both an address mapping operation and an operation of managing the mapping results.

As illustrated in FIG. 7, the mapping data management method of the inventive concepts may determine whether each of the mapping data belongs to the active area or the inactive area. The determination of such additional information may also be performed by the flash translation layer. The mapping data set to an active state may be stored in the first address mapping table Table1 provided in the local memory 1228/2280 that is a volatile memory. The mapping data set to an inactive state may be stored in the second address mapping table Table2 provided in the main storage unit 1240/2240 that is a nonvolatile memory. In a normal operation, the mapping data of the first/second address mapping table Table1/Table2 may be updated under the control of the flash translation layer.

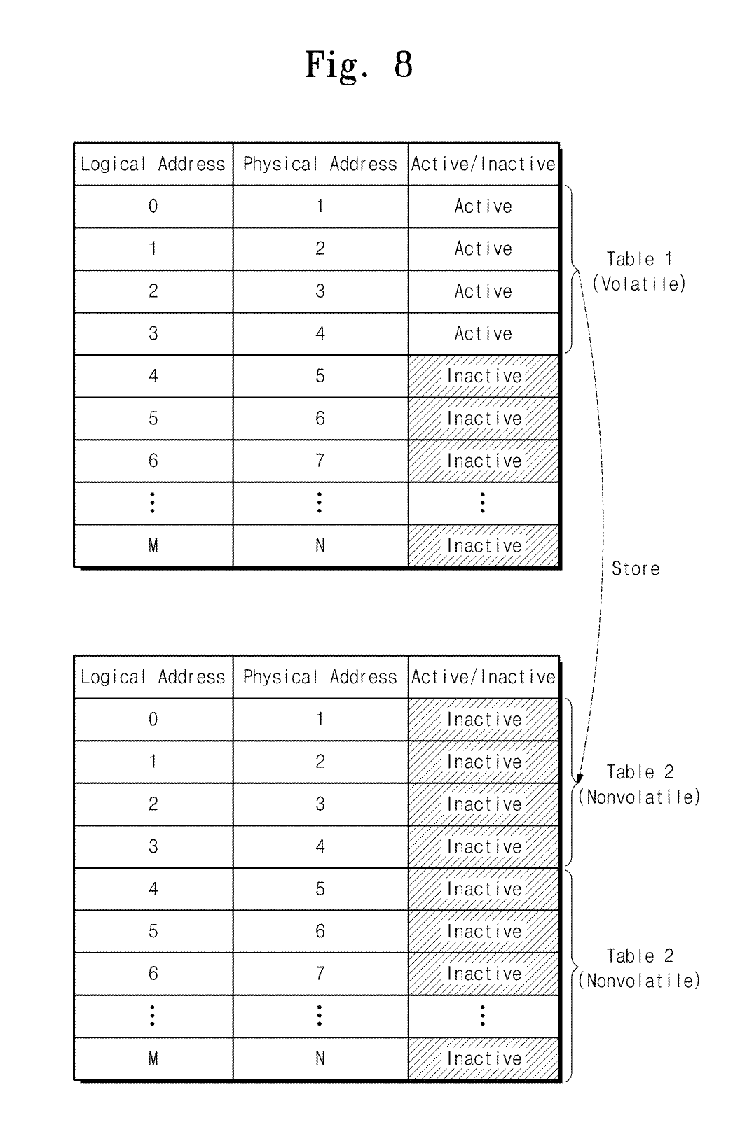

FIG. 8 illustrates an example of the structure for storing a mapping table corresponding to an active area in a mapping table corresponding to an inactive area in a power-off operation.

Referring to FIG. 8, an operating system may control information, which is being used in the host 1100/2100, to be stored in a safe space in response to a power-off request of the user. After the information used in the host 1100/2100 is stored in a safe space, a power-off notification signal may be generated to the storage device 1200/2200. The flash translation layer mounted on the storage device 1200/2200 may store the mapping data of the mapping table (i.e., the first address mapping table Table1) of an active area in the mapping table (i.e., the second address mapping table Table2) of an inactive area in response to a power-off notification signal of the host 1100/2100. According to the mapping data storage operation of the inventive concepts, an active area of the mapping table may change into an active area in a power-off operation. This means that all of the address mapping data may be retained in the nonvolatile memory in a power-off operation.

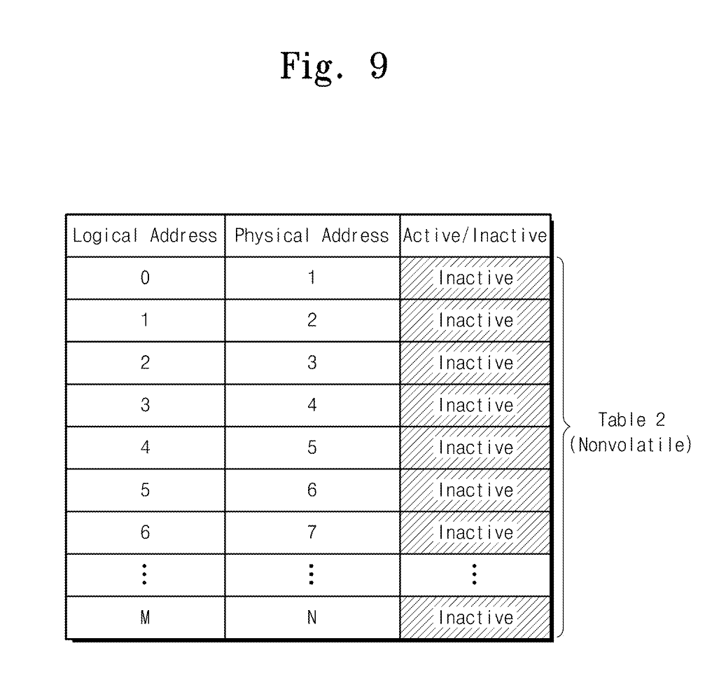

FIG. 9 illustrates an example of the structure of a mapping table in a power-off/reboot operation.

Referring to FIG. 9, all of the address mapping data belongs to an inactive area in a power-off operation. In this case, all of the address mapping data may be stored in the second address mapping table Table2 provided in the main storage unit 1240/2240. In this state, the storage device 1200/2200 may be rebooted. Due to the nonvolatile characteristics of the second address mapping table Table2, the mapping data in a power-off operation can be retained even when a reboot operation is performed.

According to the above configuration, since the address mapping data in a power-off operation and the address mapping data in a reboot operation are all in accord with each other, there is no need to recover the address mapping data. Consequently, the initial recognition time for the flash memory in a reboot operation can be reduced.

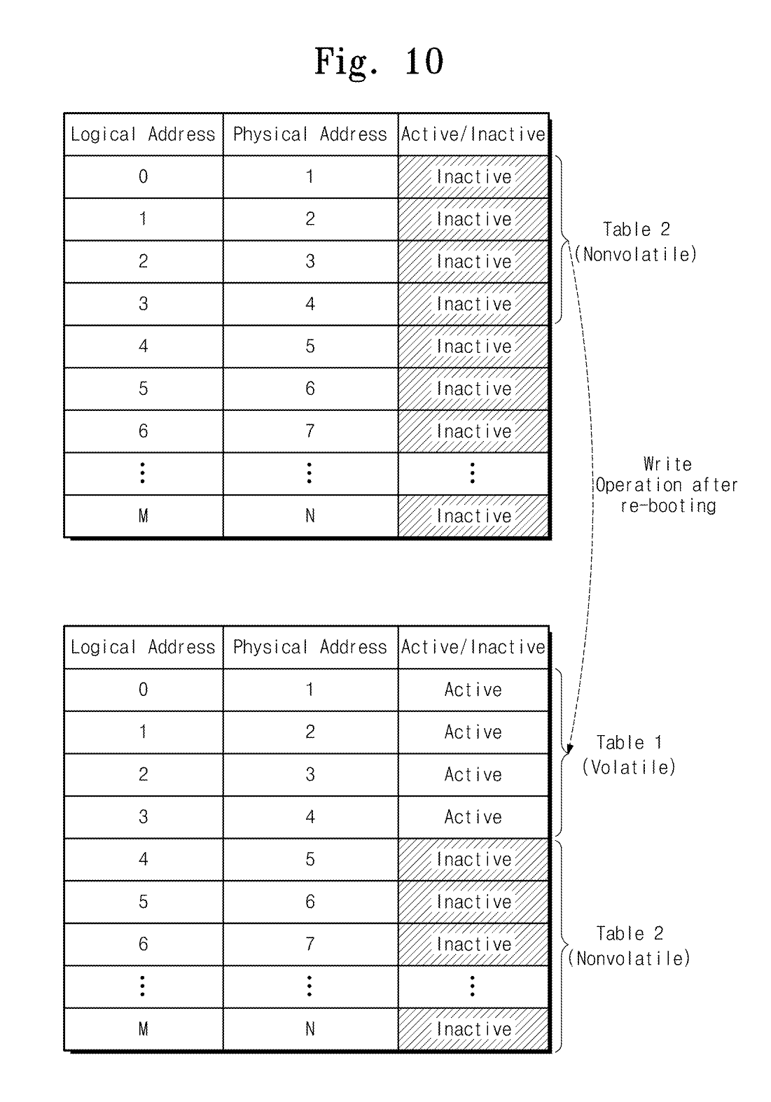

FIG. 10 illustrates an example of a mapping table management method after completion of a reboot operation.

Referring to FIG. 10, when a new write/erase/merge operation is performed after completion of a reboot operation, an area of the mapping table belonging to an active area before the reboot operation may change from an inactive state to an active state. Alternatively, an area belonging to an inactive area may be set to an inactive state. In this case, an area of the second address mapping table Table2 may be marked as being changed from an inactive state to an active state. The marking operation for the second address mapping table Table2 may be performed by the flash translation layer.

Updated mapping data are not stored in the corresponding area of the second address mapping table Table2 that changes into an active state after the reboot operation. In this case, the updated mapping data may be stored in the first address mapping table Table1, instead of being stored in the second address mapping table Table2. For example, in a write operation after the reboot operation, the mapping data of the first address mapping table Table1 may be freely updated without limitation in the overwrite/erase count. In this case, the mapping data of the corresponding area of the second address mapping table Table2, which changed into an active state, and the corresponding mapping data of the first address mapping table Table1 are not in accord with each other.

The mapping data of the first address mapping table Table1, which are stored after the reboot operation, may be stored in the corresponding area (i.e., the area marked as an active area) of the second address mapping table Table2 in a power-off operation. When data of the first address mapping table Table1 are stored in the second address mapping table Table2, the corresponding area of the second address mapping table Table2 may change from an active state to an inactive state. In this case, the mapping data of the first address mapping table Table1 and the mapping data of the corresponding area of the second address mapping table Table2, in which the data of the first address mapping table Table1 are stored, are in accord with each other.

The setting of an active/inactive area of the mapping table and the marking of an active/inactive state of the second address mapping table Table2 may be achieved by setting the log area to an active/inactive state under the control of the flash translation layer.

For example, when a new write/erase/merge operation is performed after completion of a reboot operation, a portion of the second address mapping table Table2 with an inactive state may be set to an active state. In an exemplary embodiment, the setting of an active/inactive state of the second address mapping table Table2 may be implemented by setting the log area corresponding to the second address mapping table Table2 to an active/inactive state. For example, if the log group corresponding to the second address mapping table Table2 is set to an active state, even when the mapping data corresponding to the log group set to an active state are updated, the updated mapping data are not stored in the second address mapping table Table2. In this case, the updated mapping data may be stored in the first address mapping table Table1, instead of being stored in the second address mapping table Table2. On the other hand, if the log group corresponding to the second address mapping table Table2 is set to an inactive state, the corresponding mapping data may be stored in the second address mapping table Table2.

The case of applying a log mapping scheme to an address mapping operation has been described above. However, this is merely an example, and the mapping scheme of the inventive concepts may vary according to various embodiments. For example, the address mapping scheme of the inventive concepts is not based on a log mapping scheme, the setting of an active/inactive area of the mapping table and the setting of an active/inactive state of the second address mapping table Table2 may be achieved by setting metadata under the control of the flash translation layer.

A computer program code usable for the mapping data management may be created by high-level program language such as JAVA, C, and/or C++. Also, a computer program code for execution of the operations according to the embodiments of the inventive concepts may be created by interpreted language. For improvement of the operation performance and/or the memory use, some modules or routines may be created by assembly language or microcode. Some or all of the program module functions may be implemented by separate hardware components, one or more Application Specific Integrated Circuits (ASICs), a programmed digital signal processors, or a microcontroller.

Hereinafter, the inventive concepts will be described with reference to message flow descriptions, flow charts, and/or block diagrams that illustrate methods, systems, devices and/or computer program products according to exemplary embodiments of the inventive concept. The message flow descriptions, flow charts, and/or block diagrams illustrate general operations for operating a data processing system including an external data storage device. The message flow descriptions, flow charts, and/or block diagrams and a combination thereof may be implemented by computer program commands and/or hardware operations. The computer program commands may be provided to general purpose computers, special purpose computers, or processors of other programmable data processing devices. The computer program commands may be performed through computers or programmable data processing devices to provide units for implementing functions illustrated in the message flow descriptions, flow charts, and/or block diagrams.

The computer program commands may be stored in a computer-usable or computer-readable memory so that computers or other programmable data processing devices may operate in a specific manner. That is, the commands stored in the computer-usable or computer-readable memory may provide commands for implementing the functions illustrated in the message flow descriptions, flow charts, and/or block diagrams.

The computer program commands may be loaded into in computers or other programmable data processing devices in order to provide processes performed by computers, by inducing a series of operation steps to be performed in computers or other programmable devices. The commands executed in the computers or other programmable devices may provide the operation steps for implementing the functions illustrated in the message flow descriptions, flow charts, and/or block diagrams.

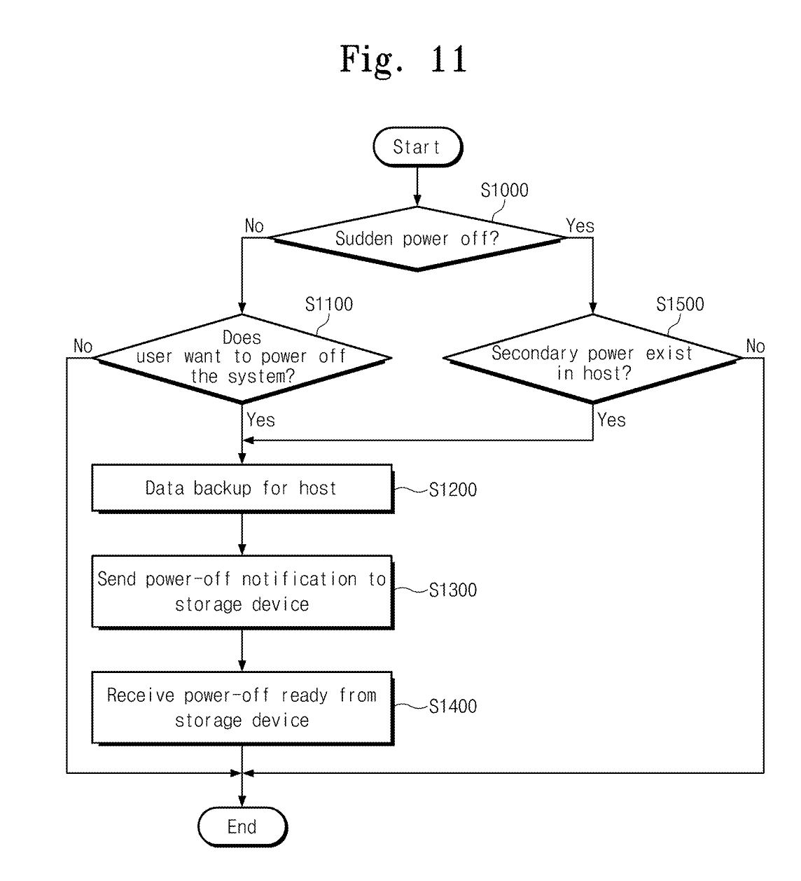

FIG. 11 is a flow chart illustrating an operation of the host for performing a mapping data management method according to an exemplary embodiment of the inventive concepts. FIG. 11 illustrates a mapping data management method that may be preformed by the host 1100/2100 in a power-off operation.

Referring to FIG. 11, in step S1000, the host 1100/2100 determines whether a sudden power-off occurs. For example, the host 1100/2100 may include a power detection unit that monitors a sudden power change to determine a sudden power off. If the level of power supplied to the host 1100/2100 decreases suddenly, or if the host 1100/2100 is a mobile device operating by battery and the available capacity of the battery decreases below a predetermined level, the power detection unit may determine that a sudden power off will occur (or has occurred) in the host 1100/2100.

If a sudden power off does not occur in step S1000, the host 1100/2100 determines whether the user wants to power off the corresponding system (i.e., the user device 1000/2000), in step S1100. Whether the user wants to power off the corresponding system may be determined according to whether a power-off command is inputted from the user to the host 1100/2100. The power-off command inputted from the user to the host 1100/2100 may be provided to an operating system (OS) mounted on the host 1100/2100. The operating system may control information, which is being used in the host 1100/2100, to be stored in a safe place in response to a power-off request of the user. Thus, data used in the host 1100/2100 may be backed up or stored in step S1200.

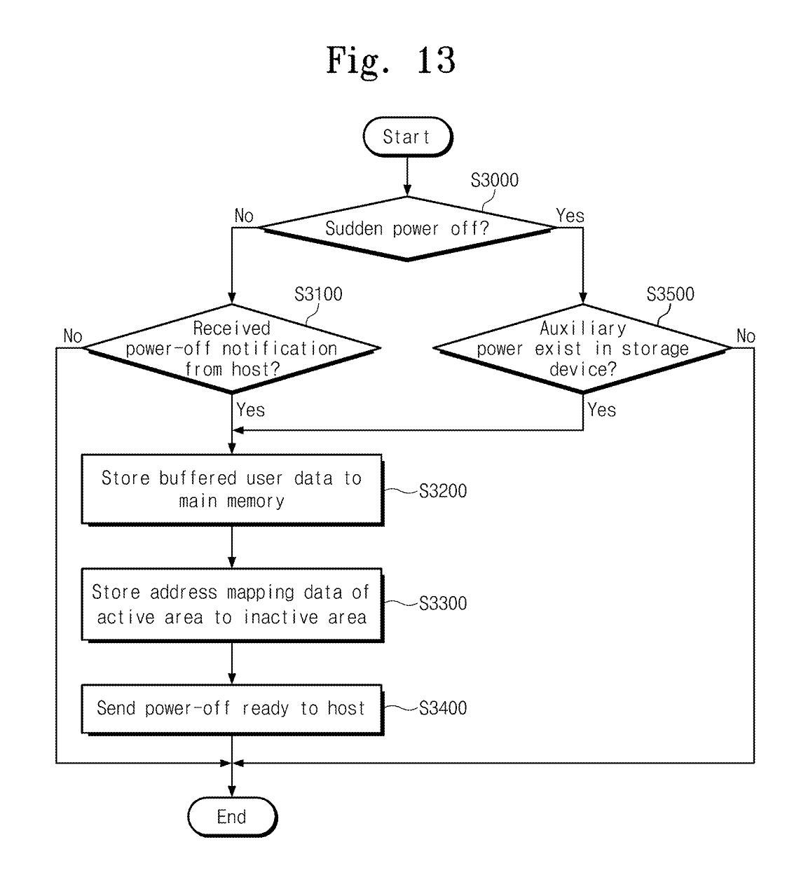

In step S1200, the data used in the host 1100/2100 is backed up or stored. In step S1300, the operating system generates a power-off notification signal to the storage device 1200/2200. In response to the power-off notification signal of the host 1100/2100, the storage device 1200/2200 may store buffered user data of the storage device 1200/2200 and address mapping data of an active area in a nonvolatile memory. The operation of the storage device 1200/2200 performed in response to the power-off notification signal of the host 1100/2100 will be described later in detail with reference to FIG. 13.

After the user data and the address mapping data are stored in the nonvolatile memory area of the storage device 1200/2200, the host 1100/2100 receives a power-off ready signal from the storage device 1200/2200 in step S1400. The power-off ready signal indicates that the storage device 1200/2200 is ready for a power off. The host 1100/2100 shuts off the power in response to the power-off ready signal. Consequently, the address mapping data and the data used in the storage device 1200/2200 and the host 1100/2100 can be stored in a safe area before the shutting off the power to the host 1100/2100.

If a sudden power off occurs in step S1000, the host 1100/2100 determines whether a secondary power source exists in the host 1100/2100, in step S1500. If no secondary power source exists in the host 1100/2100 in step S1500, the operation is ended. If a secondary power source exists in the host 1100/2100 in step S1500, the operation proceeds to step S1200.

After the data used in the host 1100/2100 is backed up or stored in step S1200, the user data buffered in the storage device 1200/2200 and the address mapping data of an active area are stored in a nonvolatile memory area in steps S1300 and S1400. Thereafter, the power to the host 1100/2100 may be shuts off. The power supplied to the storage device 1200/2200 in a sudden power-off mode may be received from an auxiliary power source of the host 1100/2100. For example, if the primary power source of the host 1100/2100 is an AC power, the auxiliary power source supplying power to the host 1100/2100 in a sudden power-off mode may be a battery or a battery pack. If the primary power source of the host 1100/2100 is a battery or a battery pack, the auxiliary power source supplying power to the host 1100/2100 in a sudden power-off mode may be a small battery, a charger or other power source (e.g., a charging device and a large capacitor).

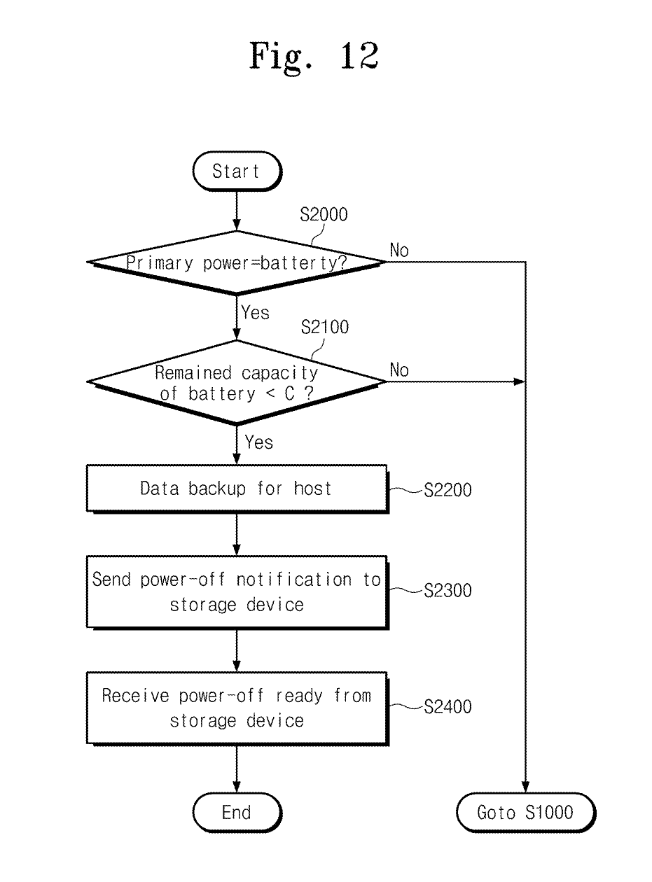

FIG. 12 is a flow chart illustrating an operation of the host for performing a mapping data management method according to an exemplary embodiment of the inventive concepts. FIG. 12 illustrates an operation that may be performed according to the remaining battery capacity if the host 1100/2100 is a mobile device capable of receiving main power from a battery like a laptop computer.

Referring to FIG. 12, in step S2000, it is determined whether a primary power source is a battery. If it is determined in step S2000 that the primary power source is not a battery, the operation proceeds to step S1000 of FIG. 11 to perform the operation of the host 1100/2100 described with reference to FIG. 11. If it is determined in step S2000 that the primary power source is a battery, a determination is made in step S2100 as to whether the remaining battery capacity is smaller than a predetermined reference value C. To this end, the host 1100/2100 may include a power detection unit for monitoring a battery power change or the remaining battery capacity.

If it is determined in step S2100 that the remaining battery capacity is not smaller than the predetermined reference value C, the operation proceeds to step S1000 of FIG. 11 to perform the operation of the host 1100/2100 described with reference to FIG. 11. If it is determined in step S2100 that the remaining battery capacity is smaller than the predetermined reference value C, the operating system (OS) mounted in the host 1100/2100 controls information, which is being used in the host 1100/2100, to be backed up or stored in a safe place in response to a detection signal from the power detection unit, in step S2200.

Thereafter, in step S2300, the operating system generates a power-off notification signal to the storage device 1200/2200. In response to the power-off notification signal of the host 1100/2100, the storage device 1200/2200 stores the buffered user data of the storage device 1200/2200 and the address mapping data of an active area in a nonvolatile memory area.

After the user data and the address mapping data are stored in the nonvolatile memory area of the storage device 1200/2200, the host 1100/2100 receives a power-off ready signal from the storage device 1200/2200 in step S2400. Also, the host 1100/2100 shuts off the power in response to the power-off ready signal.

Consequently, the address mapping data and the data used in the storage device 1200/2200 and the host 1100/2100 can be stored in a safe area before the shutting off the power to the host 1100/2100.

FIG. 13 is a flowchart illustrating a method for managing mapping data in storage devices 1200 and 2200 according to an embodiment of the inventive concept.

Referring to FIG. 13, in operation S3000, the storage devices 1200 and 2200 may determined whether a sudden power-off is generated. For example, the storage devices 1200 and 2200 may include a power detection unit detecting a sudden power-off by monitoring a sudden variation of a power of hosts 1100 and 2100. The power detection unit may determine a sudden power-off as being generated when the level of a power provided to the hosts 1100 and 2100 is rapidly dropped or when the capacity of a battery is reduced under a certain level in the case where the hosts are mobile devices powered by batteries.

If the sudden power-off is not generated in the determination result of operation S3000, in operation S3100, the storage devices 1200 and 2000 may determine whether a power-off notification signal is received from the hosts 1100 and 2100.

If the storage devices 1200 and 2000 have received the power-off notification signal from the hosts 1100 and 2100 in the determination result of operation S3100, in operation S3200, the storage devices 1200 and 2200 may store user data buffered in local memories 1228 and 2280 in main memories 1240 and 2240 by the control of storage controllers 1220 and 2220.

For example, processing units of the storage controllers 1220 and 2220 may generate a flush control signal to the local memories 1228 and 2280 in response to the power-off notification signal received from the hosts 1100 and 2100. The local memories 1228 and 2280 may forcibly store the user data of the local memories 1228 and 2280 in the main memories 1240 and 2240 in response to the flush control signal generated from the storage controllers 1220 and 2220. Once the user data is stored in the main memories 1240 and 2240 by the flush operation, a mapping address about the corresponding data may be updated to be stored in an area of corresponding address mapping data.

In operation S3300, the processing units of the storage controllers 1220 and 2220 may control address mapping data of an active area to be stored in an inactive area.

In an exemplary embodiment, a mapping table area stored in the local memories 1228 and 2280 that are volatile memories may be defined as an active area, and a mapping table area stored in the main memories 1240 and 2240 that are nonvolatile memories may be defined as an inactive area. An operation of storing the address mapping data of the active area in the inactive area may be performed in response to the flush control signal generated from the processing units of the storage controllers 1220 and 2220.

After the address mapping data of the active area is stored in the inactive area in operation S3300, the processing units of the storage controllers 1220 and 2220 may generate a power-off ready to the hosts 1100 and 2100 in operation S3400.

On the other hand, when a sudden power-off has been generated in the determination result of operation S3000, it may be determined in operation S3500 whether an auxiliary power source exists in the storage devices 1200 and 2200. When the auxiliary power source does not exist in the storage devices 1200 and 2000 in the determination result of operation S3500, the process ends.

When the auxiliary power source exists in the storage devices 1200 and 2200 in the determination result of operation S3500, the process proceeds to operation S3200. In operation S3200, the storage devices 1200 and 2200 may store the user data buffered in the local memories 1228 and 2280 in the main memories 1240 and 2240 by the control of the storage controllers 1220 and 2220. Thereafter, in operation S3300, the address mapping data of the active area may be stored in the inactive area.

In an exemplary embodiment, when a sudden power-off is detected, the storage devices 1200 and 2200 may be configured to store on its own the user data buffered in the storage devices 1200 and 2200 and the address mapping data of the active area in the nonvolatile memory areas (i.e., main memories) even though the storage devices 1200 and 2200 does not receive a separate command from the hosts 1100 and 2100. In this case, power provided to the storage devices 1200 and 2200 may be provided from its own auxiliary power source provided in the storage devices 1200 and 2200. Here, the auxiliary power source may include a battery or a power source unit (e.g., a charging device, a large capacitor, etc.) similar thereto. A configuration of an auxiliary power source that may be provided in the storage devices 1200 and 2200 and a method of operating the same are disclosed in commonly assigned US Patent Publication No. 2010/0146333, entitled “AUXILIARY POWER SUPPLY AND USER DEVICE INCLUDING THE SAME,” the entire contents of which are hereby incorporated by reference.

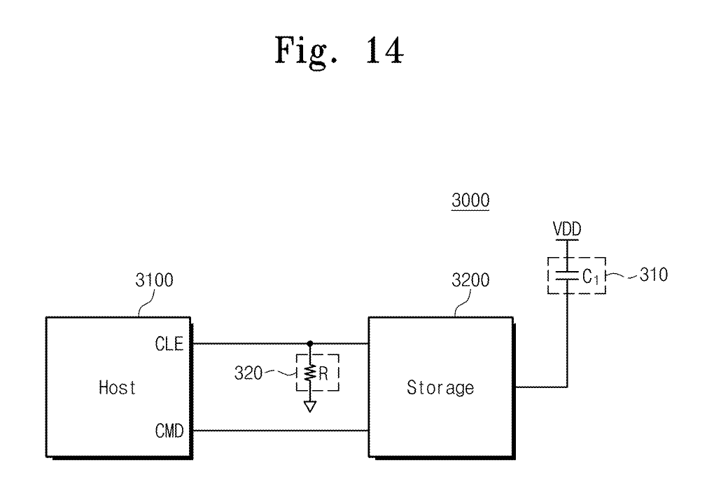

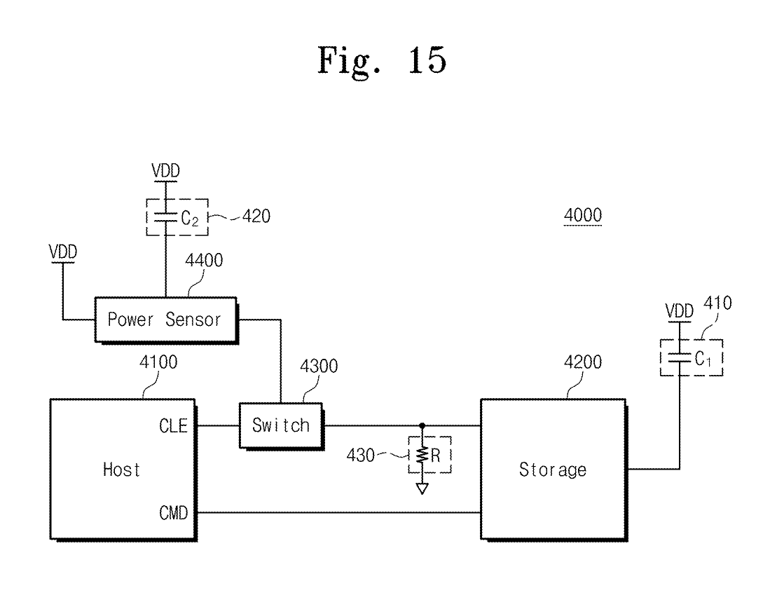

FIGS. 14 and 15 are diagrams illustrating configurations of user devices 3000 and 4000 having an auxiliary power source in the storage devices 1200 and 2200. A configuration of an auxiliary power source and a method of operating the same are disclosed in Korean Patent Application No. 2008-26963, entitled “FLASH MEMORY SYSTEM,” the entire contents of which are hereby incorporated by reference.

Referring to FIG. 14, the user device 3000 may include a host 3100, a storage device 3200, a charging unit 310, and a pull-down driving unit 320.

The host 3100 may have the same configuration as the hosts 1100 and 2100 shown in FIGS. 1 and 5. The storage device 3200 may have the same configuration as the storage devices 1200 and 2200 shown in FIGS. 1 and 5. Accordingly, detailed description of the host 3100 and the storage device 3200 will be omitted herein.

The host 3100 may provide an activated command latch enable signal to the storage device 3200. The storage device 3200 may receive a command from the host 3100 in response to the active command latch enable (hereinafter, referred to as CLE) signal. The storage device 3200 may perform a corresponding operation (program or erase operation), in response to the command received from the host 3100. When the CLE signal is inactivated, the storage device 3200 may not receive a command from the host 3100 in response to the inactivated CLE signal.

In an exemplary embodiment, the pull-down driving unit 320 may be configured with a resistance R. Here, the resistance R may be configured with a pull-down resistance. Upon sudden power-off, the pull-down driving unit 320 may inactivate the CLE signal by discharging the CLE signal in a ground voltage. As the CLE signal is inactivated, the storage device 3200 may not receive an additional command from the host during the sudden power-off

In an exemplary embodiment, the charging unit 310 may be configured with a capacitor C1. When the sudden power-off is generated, the charging unit 310 may supply charged power to the storage device 3200 such that the operation of the storage device 3200 is stably performed according to the command transmitted before the sudden power-off. In this case, the storage device 3200 may store the address mapping data of the active area in the inactive area in response to the inactivated CLE signal. The storage operation of the address mapping data may be performed after the operation of the storage device 3200 has been stably performed according to the command transmitted before the sudden power-off.

Referring to FIG. 15, the user device 400 according to another embodiment of the inventive concepts may include a host 4100, a storage device 4200, a switch 4300, a power sensor 4400, a first charging unit 410, a second charging unit 420, and a pull-down driving unit 430. The connection configuration and operation of the host 4100, the storage device 4200, the pull-down driving unit 430, and the first charging unit 410 may be substantially identical to those described in FIG. 14. Accordingly, a detailed description thereof will be omitted herein.

The second charge unit 420 may be configured with a capacitor C2. The second charging unit 420 may supply charged power to the power sensor 4400 such that the power sensor 4400 can be normally operated even in the sudden power-off.

The power sensor 4400 may be connected to a power source VDD. Accordingly, the power sensor 440 may detect generation of a sudden power-off when the power source VDD is suddenly powered off. The power sensor 4400 may control an on/off operation of the switch 4300 based on the detection result of the power sensor 4400. For example, the power sensor 4400 may control the switch 4300 to be off when a sudden power-off is detected. When the switch 4300 is off, a CLE signal may not be transmitted to the storage device 3200, and an additional command may not be transmitted from the host 4100 to the storage device 3200 after the sudden power off.

In an exemplary embodiment, the first charging unit 410 may be configured with a capacitor C1. When the sudden power-off is generated, the first charging unit 410 may supply charged power to the storage device 4200 such that the operation of the storage device 4200 is stably performed according to the command transmitted before the sudden power-off. In this case, the storage device 4200 may store the address mapping data of the active area in the inactive area in response to the inactivated CLE signal.

According to the above configuration of an exemplary embodiment of the inventive concepts, when an unexpected sudden power-off as well as a normal power-off occurs, an address mapping result of an active area may be stored in an inactive area before the power is shut off.

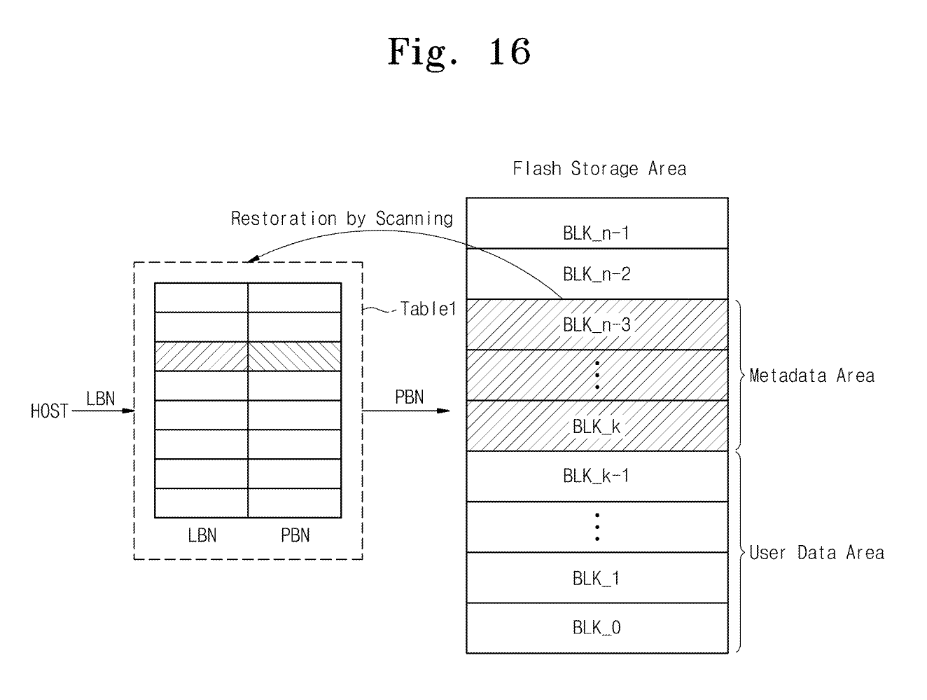

FIG. 16 is a diagram illustrating an address mapping data restoring method that can be performed when an auxiliary power source is absent in the storage devices 1200 and 2200 and a sudden power-off occurs.

Referring to FIG. 16, a memory device such as a flash memory device may have to be rebooted when a severe error occurs during the operation of the memory device. For example, a sudden power-off may occur due to an unexpected power failure (e.g., power outrage). When an unexpected power failure occurs, data may be restored by recovering address mapping information of blocks during a rebooting. FIG. 16 illustrates a method of restoring mapping information of a first address mapping table Table1 that can be stored in a volatile memory. In FIG. 16, a portion of the address mapping table represented as LBN may refer to a logic block address, and a portion represented as PBN may refer to a physical block address.

In an exemplary embodiment, blocks may be scanned upon rebooting to read additional information from a specific area of the respective blocks, and address mapping information may be restored using the additional information. For example, hints may be stored in a partial area of a flash memory (e.g., a metadata area) that may be used to restore the address mapping information of the blocks.

For example, the hints stored in the partial area of the flash memory may include block array information, wear-leveling information, block allocation information, erase information, and garbage information that are configured in a tree form. A flash translation layer may restore the address mapping information to a status just before a power-off by using the above hints during a rebooting. The restored address mapping information, which is mapping information included in the active area (i.e., Table1), may correspond to mapping information that could not been stored in the inactive area due to the sudden power-off. In this case, since the active area is only a portion of the whole mapping table area, the address mapping information of the active area may be enough restored in a short time during the rebooting.

Looking at the operation characteristics of the user device, the frequency of the sudden power-off may be extremely low when compared to the frequency of a normal power-off performed by a user's request. Accordingly, in most cases, the power may be shut off by the normal power-off after all mapping data of the active area are stored in the inactive area. That is, in case of driving of the user device, the case where mapping information included in the active area have to be restored may be extremely rare.

Therefore, the user device to which the mapping data management method according to an embodiment of the inventive concepts can reduce an information maintenance cost of an address mapping table and considerably improve the performance of a storage equipped with flash memories even where an expensive auxiliary power source or charging unit is not provided in the storage device.

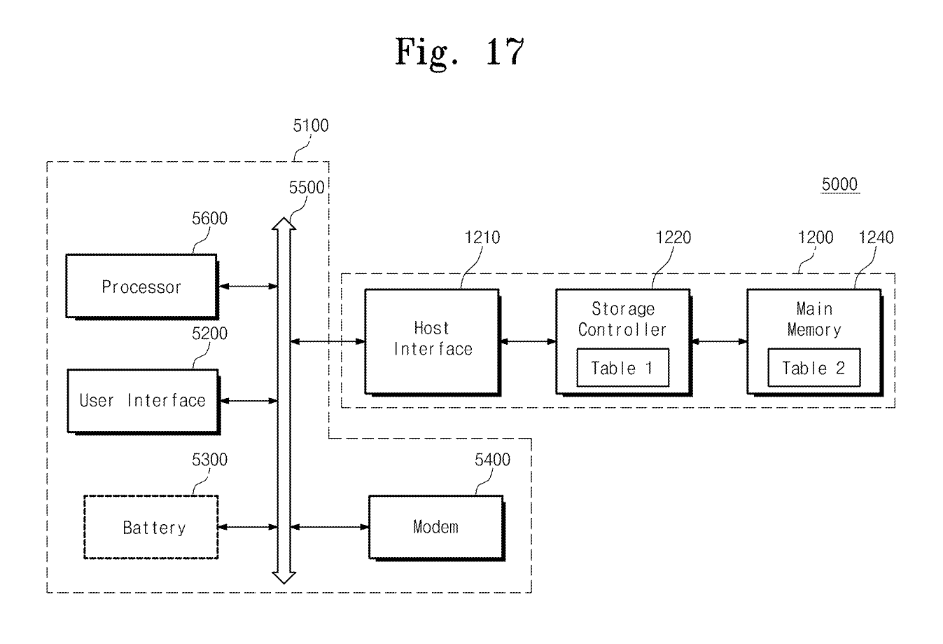

FIG. 17 is a diagram illustrating a configuration of a user device 5000 according to still another embodiment of the inventive concepts. The user device 5000 may include a storage device 1200 according to an embodiment of the inventive concept.

Referring to FIG. 17, the user device 500 may include mobile devices such as personal computers, digital cameras, camcorders, mobile phones, MP3s, PMPs, PDAs. The user device 5000 may be divided into a host 5100 and a storage device 1200.

The host 5100 may include a user interface 5200 electrically connected to a system bus 550, a modem 5400 such as a baseband chipset, and a processor 5600. Although not shown in FIG. 17, the host 5100 may further include various kinds of memories (for example, volatile memories such as DRAM and SRAM and nonvolatile memories such as EEPROM, FRAM, PRAM, MRAM, and flash memories) therein. The host 5100 may perform interfacing with external devices through the user interface 5200. The user interface 5200 may support at least one of various interface protocols such as USB, MMC, PCI-E, SAS, SATA, SAS, PATA, SCSI, ESDI, and IDE.

The storage device 1200 may configured with a storage device such as a memory card, a USB memory, a Solid State Drive (SSD), and Hard Disk Drive (HDD). The storage device 1200 may include a host interface 1210, a storage controller 1220, and a main memory 1240.

The host interface 1210 may be connected between the system bus 550 and the storage controller 1220 to provide a physical connection between the host 5100 and the storage device 1200. The storage controller 1220 may perform interfacing with the main memory 1240 through the host interface 1210 that supports a bus format of the host 5100. For example, the storage controller 1220 may be configured to support at least one of various interface protocols such as USB, MMC, PCI-E, SAS, SATA, SAS, PATA, SCSI, ESDI, and IDE. Here, the host interface 1210 may be provided in the inside or the outside of the storage controller 1220. The configuration of the host interface 1210 may be variously changed or modified without being limited to a specific configuration. In addition, a flash interface (not shown) may be provided in the storage device 1200 to provide an interface between the storage controller 12200 and the main memory 1240.

The main memory 1240 may be provided in a multi-chip package configured with a plurality of flash memory chips. The main memory 1240 may include volatile memories such as DRAM and SRAM and nonvolatile memories such as EEPROM, FRAM, PRAM, MRAM, and flash memories.

The storage controller 1220 may control read/write/erase operations of the main memory 1240 in response to a request from the processor 5600. Also, the storage controller 1220 may include a flash translation layer to perform logic address-physical address mapping information management, bad block management, data conservation management according to an unexpected power-off, and wear leveling.

For example, FTL may perform a role of mapping a logic address generated by a file system upon subscription operation of a flash memory to a physical address where an erase operation has been performed. The FTL may use an address mapping table for a quick address mapping. In an exemplary embodiment of the inventive concepts, the address mapping table may be divided into an active area where address mapping data is stored in a volatile memory and an inactive area where address mapping data is stored in a nonvolatile memory. In FIG. 17, an address mapping table corresponding to an active area is represented as Table1, and an address mapping table corresponding to an inactive area is represented as Table2. The address mapping data of the active area Table1 may be stored in the inactive area Table2 before a power-off, in response to a power-off notification signal generated from a host (not shown) or a processor 5600. As a result, all address mapping data may be stored in the nonvolatile memory before the power-off, thereby ensuring consistency of data without restoring the address mapping data upon rebooting.

When the user device 5000 according to an embodiment of the inventive concept is a mobile device such as a laptop computer, a battery 5300 may be additionally provided to provide an operating voltage to the user device 5000. Although not shown, the user device 5000 may further include an application chipset, a Camera Image Processor (CIS), and a mobile DRAM.

The user device 5000 may determine a sudden power-off as being generated in the user device 5000 when the power level of the battery 5300 is rapidly dropped or when the capacity of the battery 5300 is reduced under a certain level. In this case, the user device 5000 may allow the storage device 1200 to store the address mapping data of the active area Table1 in the inactive area Table2 by generating a power-off notification signal via the processor 5600 before the capacity of the battery 5300 is completed exhausted.

The user device 5000 may further include an auxiliary battery serving as an auxiliary power source or a power source unit (e.g., a charging device and a large capacitor) similar thereto. When power is not smoothly supplied from the battery 5300, the user device 5000 may use an auxiliary power source to supply power to the user device 5000. While an auxiliary power source is supplying power to the user device 5000, a power-off notification signal may be generated through the processor 5600. As a result, the storage device 1200 may store the address mapping data of the active area Table1 in the inactive area Table2 in response to the power-off notification signal.

In addition, the auxiliary power source may also be provided in the storage device 1200. In an exemplary embodiment of the inventive concept, even when power is not supplied by the battery 5300 of the user device 5000, the auxiliary power source provided in the storage device 1200 may supply power to the storage device 1200 for a certain time. That is, while the auxiliary power source provided in the storage device 1200 is supplying power to the storage device 1200, the address mapping data of the active area Table1 may be stored in the inactive area Table2.

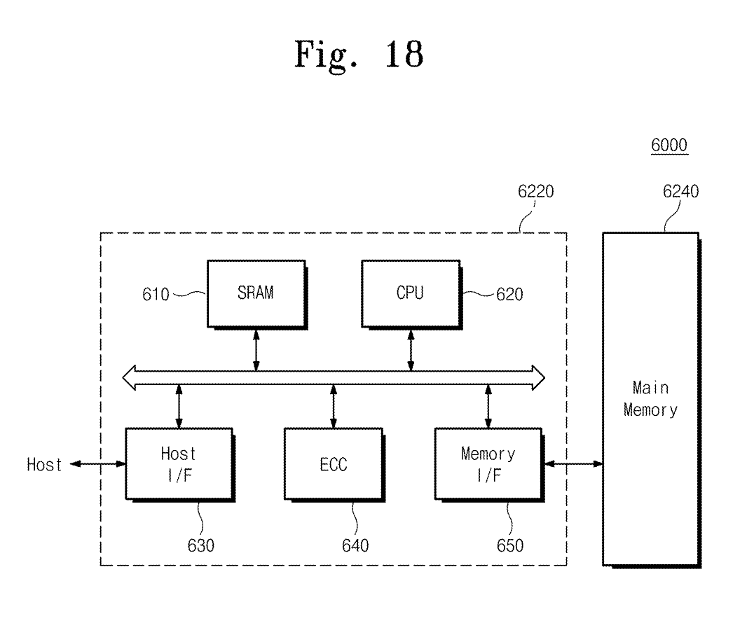

FIG. 18 is a diagram illustrating a configuration of a storage device 6000 according to another embodiment of the inventive concepts.

Referring to FIG. 18, the storage device 6000 may include a storage controller 6220 and a main memory 6240.

The main memory 6240 of FIG. 18 may be configured identically to the main memory 1240 shown in FIGS. 1, 4 and 17 and the main memory 2240 shown in FIG. 5. In an exemplary embodiment, the main memory 6240 may be configured with flash memories among nonvolatile memories. The storage device 6000 of FIG. 18 may comply with the mapping data management method according to an embodiment of the inventive concepts. Accordingly, address mapping data of an active area stored in a volatile memory may be stored in an inactive area of a nonvolatile memory.

The storage controller 6220 may be configured to control the main memory 6240. The storage controller 6220 may be configured identically to the storage controller 1220 shown in FIGS. 1, 4 and 17 and the storage controller 2220 shown in FIG. 5. Accordingly, detailed description thereof will be omitted herein.

The storage device 6000 according to an embodiment of the inventive concept may be applied to one of computers, mobile computers, Ultra Mobile PCs (UMPCs), work stations, net-books, Personal Digital Assistants (PDAs), portable computers, web tablets, wireless phones, mobile phones, smart phones, digital cameras, digital audio recorders, digital audio players, digital picture recorders, digital picture players, digital video recorders, digital video players, devices capable of sending/receiving data in wireless environments, and various electronic devices constituting a home network.

The storage device 6000 may also be applied to one of various electronic devices constituting a computer network and one of various electronic devices constituting a telematics network. In addition, the storage device 6000 may also be applied to one of RFID devices and various components (e.g., SSDs and memory cards) constituting a computing system. For example, memory cards and SSDs may be configured with a combination of the main memory 6240 and the storage controller 6220. In this case, the storage controller 6220 may serve as a memory controller.

An SRAM 610 may be used as a working memory of a processing unit 620. A host interface 630 may include a data exchange protocol of a host connected to the storage device 6000. An error correction circuit 640 provided in the storage controller 6220 may detect and correct errors of read data that have been read from the main memory 6240. A memory interface 650 may interface with the main memory 6240. The processing unit 620 may perform overall control operations for data exchange of the storage controller 6220. Although not shown in the drawing, the storage device 6000 according to an embodiment of the inventive concepts may be further provided with a ROM (not shown) storing code data for interfacing with a host.

The main memory 6240 may be provided in the form of a multi-chip package including a plurality of flash memory chips. The storage device 6000 according to an embodiment of the inventive concepts may be configured with storage media having low error rate and high reliability. Particularly, the storage device 6000 may be configured with memory systems such as SSDs that are being actively studied in recent years. In this case, the storage controller 6220 may be configured to communicate with external devices (e.g., host) via one of various interface protocols such as USB, MMC, PCI-E, SAS, SATA, SAS, PATA, SCSI, ESDI, and IDE.

The storage device 6000 may be mounted in various types of packages. The main memory 6240 and/or the storage controller 6220 may be mounted with packages such as Package on Package (PoP), Ball Grid Arrays (BGA), Chip Scale Packages (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP). The package characteristics of the storage devices may be identically applied to the storage device 1200 shown in FIGS. 1, 4 and 17, the storage device 2200 shown in FIG. 5, the storage device 3200 shown in FIG. 14, and the storage device 4200 shown in FIG. 15, as well as the storage device 6000 shown in FIG. 18.

According to embodiments of the inventive concepts, before the power of the storage device is turned off, all the mapping information stored in the volatile memory can be stored in the nonvolatile memory.

Accordingly, in the rebooting operation of the storage device, the mapping table need not be reconfigured, and an initial recognition time for a flash memory can be minimized. Moreover, the information maintaining cost of the address mapping table can be reduced, and the performance of the storage device including the flash memory can be improved.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A mapping data management method comprising:
storing data that is being used by a host in response to a power-off command from a user;
generating, by the host, a power-off notification signal to a storage device; and
storing, by the storage device, mapping data of a volatile memory in a nonvolatile memory in response to the power-off notification signal.

2. The method of claim 1, wherein the power-off notification signal is generated from an operating system of the host.

3. The method of claim 1, further comprising storing, by the storage device, the mapping data of the volatile memory in the nonvolatile memory using an auxiliary power source upon a sudden power-off condition.

4. The method of claim 1, wherein the volatile memory comprises a first mapping table storing mapping data, which is set as an active area.

5. The method of claim 4, wherein the nonvolatile memory comprises a second mapping table storing mapping data, which is set as an inactive area.

6. The method of claim 5, wherein the mapping data of the volatile memory is stored in the second mapping table.

7. The method of claim 5, further comprising:
rebooting the storage device;
setting, by the storage device, a first area of the second mapping table as an active area from the inactive area;
storing, by the storage device, mapping data of the first area in the volatile memory;
storing, by the storage device, the mapping data of the volatile memory in the first area when the power-off notification signal is inputted; and
resetting, by the storage device, the first area as the inactive area.

8. A mapping data management method, comprising:
receiving, by an operating system, a power-off command inputted from a user;
storing, by the operating system, data that being used by a host in response to the power-off command;
generating, by the operating system, a power-off notification signal to a storage device; and
storing, by the storage device, mapping data of a volatile memory in a nonvolatile memory in response to the power-off notification signal.

9. A user device comprising:
a host storing data that is being used in response to a power-off command inputted from a user and generating a power-off notification signal; and
a storage device mapping data of a volatile memory in a nonvolatile memory in response to the power-off notification signal.

10. The user device of claim 9, wherein the host is equipped with an operating system that generates the power-off notification signal to the storage device in response to the power-off command.

11. The user device of claim 9, wherein the storage device comprises:
a main memory comprising the nonvolatile memory as a data storage; and
a controller controlling an operation of the main memory, the controller comprising the volatile memory device.

12. The user device of claim 9, wherein the storage device further comprises an auxiliary power source that supplies power to the storage device upon a sudden power-off condition, and the mapping data stored in the volatile memory is stored in the nonvolatile memory while the power is supplied from the auxiliary power.

13. The user device of claim 9, wherein the volatile memory comprises a first mapping table storing mapping data, which is set as an active area.

14. The user device of claim 13, wherein the nonvolatile memory comprises a second mapping table storing mapping data, which is set as an active area.

15. The user device of claim 14, wherein the mapping data stored in the volatile memory is stored in the second mapping table.

16. The user device of claim 14, wherein a first area of the second mapping table is set as an active area after the storage device is rebooted.

17. The user device of claim 16, wherein, upon a normal operation, mapping data of the first area is stored or updated in the volatile memory according to a control of a flash translation layer.

18. The user device of claim 16, wherein, when the power-off notification signal is inputted, the mapping data stored in the volatile memory is stored in the first area according to a control of a flash translation layer, and the first area is reset as the inactive area.

19. The user device of claim 18, wherein the flash translation layer sets the first area as the active area or the inactive area by setting a log area corresponding to the first area as an active state or an inactive state.

20. The user device of claim 18, wherein the flash translation layer sets the first area as the active area or the inactive area by setting additional information corresponding to the first area as a form of metadata.
